(19) United States
(12) Patent Application Publication
(10) Pub. No.: US 2023/0419043 A1
(43) Pub. Date: Dec. 28, 2023

(54) METHOD, DEVICE, AND NON-TRANSITORY COMPUTER-READABLE RECORDING MEDIUM TO PROVIDE CONVERSATIONAL CONTENT IN ROLE-PLAYING FORMAT

(71) Applicant: NAVER CORPORATION, Seongnam-si (KR)

(72) Inventors: Sua LEE, Seongnam-si (KR); Somi KIM, Seongnam-si (KR); Jonghwan KIM, Seongnam-si (KR); Hye Seung SEO, Seongnam-si (KR); Dongwoon KIM, Seongnam-si (KR); JeeHye SUNG, Seongnam-si (KR); Yanchen ZHOU, Seongnam-si (KR); Longri JIN, Seongnam-si (KR)

(21) Appl. No.: 18/338,786

(22) Filed: Jun. 21, 2023

(30) Foreign Application Priority Data
Jun. 28, 2022 (KR) 10-2022-0078880

(51) Int. Cl. G06F 40/30; G06F 40/40

(52) U.S. Cl. CPC G06F 40/30; G06F 40/40

(57) ABSTRACT

A conversation learning service method includes registering audio uttered by a first learning participant as pronunciation content in an accent that represents the first learning participant's country of origin, ethnicity, or region; and providing a conversational text including at least two sentences in a role-playing format using the pronunciation content corresponding to the sentence.

### CROSS-REFERENCE TO RELATED APPLICATION(S)

This U.S. non-provisional application claims the benefit of priority under 35 U.S.C. § 119 to Korean Patent Application No. 10-2022-0078880 filed on Jun. 28, 2022, in the Korean Intellectual Property Office (KIPO), the entire contents of which are incorporated herein by reference.

### BACKGROUND OF THE INVENTION

### Field of Invention

One or more example embodiments of the present invention in the following description relate to technology for providing a conversational text for language learning.

### Description of Related Art

All language education including English education has mostly been performed in an offline manner in which instructors deliver educational contents in classrooms, but is currently expanding to online education methods through the Internet.

Online education methods include a video lecture method of transmitting an education course of an instructor to students through the Internet, an education method using an electronic blackboard and voice, and a video conference system (VCS) method for video chatting.

As an example of an online education method, a method for studying English pronunciation using a basic word pronunciation that may accurately learn the pronunciation of words or sentences using the Internet is disclosed in Korean Patent Registration No. 10-0816378 (registered on Mar. 18, 2008).

### BRIEF SUMMARY OF THE INVENTION

One or more example embodiments may construct pronunciation content recorded by a user having a corresponding accent into a database for each accent and may provide a conversation learning platform using the database.

One or more example embodiments provide a service that allows a user to record or listen to pronunciation content for a conversational text on a topic selected by the user in a role-playing format.

One or more example embodiments provide user experience in a form in which a user having an accent selected by a user appears as a counterpart of a role-playing conversation and converses with the user.

One or more example embodiments may expand a conversation tree through participation in free talking and may generate a conversational text in various scenarios.

According to an aspect of at least one example embodiment, there is provided a conversation learning service method executed on a computer device having at least one processor configured to execute computer-readable instructions recorded in a memory, the conversation learning service method including registering, by the at least one processor, audio uttered by a first learning participant as pronunciation content in an accent for each accent that represents the first learning participant's country of origin, ethnicity, or region; and providing, by the at least one processor, a conversational text including at least two sentences in a role-playing format using the pronunciation content corresponding to the sentence.

The providing of the conversational text in the role-playing format may include providing a conversational text on a specific topic selected by a second learning participant in a role-playing format using pronunciation content in a specific accent selected by the second learning participant.

The providing of the conversational text in the role-playing format may include providing a first role interface for playing back the pronunciation content and a second role interface for recording uttered voice of a second learning participant with respect to sentences that are sequentially given in sentence order of the conversational text.

The providing of the conversational text in the role-playing format may include providing a first role interface for playing back pronunciation content in a first accent and a second role interface for playing back pronunciation content in a second accent different from the first accent with respect to sentences that are sequentially given in sentence order of the conversational text.

The conversation learning service method may further include registering, by the at least one processor, the uttered voice as pronunciation content in an accent corresponding to the second learning participant.

The first role interface may include profile information of the first learning participant that registers the pronunciation content, and the second role interface may include profile information of the second learning participant.

The second role interface may include an interface for setting a tone of emotion for the uttered voice.

The second role interface may include an interface for inputting a sentence different from that of the conversational text, and the conversation learning service method may further include adding, by the at least one processor, a different sentence to a conversation tree that includes the sentences of the conversational text and generating a new conversational text based on the conversation tree.

The providing of the first role interface and the second role interface may include highlighting and displaying profile information corresponding in turn between the profile information of the first learning participant and the profile information of the second learning participant.

The providing of the conversational text in the role-playing format may further include sequentially displaying sentences each in which playback of the pronunciation content or recording of the uttered voice is completed as message speech bubbles.

The providing of the conversational text in the role-playing format may further include providing at least one of an interface for playing back a pronunciation content and an interface for inputting a positive response in units of sentences each in which playback of the pronunciation content or recording of the uttered voice is completed.

The providing of the conversational text in the role-playing format may include providing a list of first learning participants selectable as a role-playing opponent based on at least one of a real-time access status and a relationship with the second learning participant.

The providing of the conversational text in the role-playing format may include providing a topic list that includes topics selectable as a learning topic; and providing a conversational text on a specific topic selected from the topic list as content for language learning of a second learning participant.

The providing of the topic list may include displaying topic information for each topic included in the topic list, and the topic information may include profile information of at least one first learning participant that participates in recording of a conversational text belonging to a corresponding topic.

The topic information may include at least one of an object related to the corresponding topic, the number of conversational texts belonging to the corresponding topic, and the number of first learning participants that participate in recording of the conversational text belonging to the corresponding topic.

The topic information may include history information of the second learning participant on the conversational text belonging to the corresponding topic.

According to another aspect, there is provided a non-transitory computer-readable recording medium storing instructions that, when executed by a processor, cause the processor to perform the conversation learning service method on a computer device.

According to still another aspect, there is provided a computer device including at least one processor configured to execute computer-readable instructions recorded in a memory. The at least one processor is configured to process registering audio uttered by a first learning participant as pronunciation content in an accent that represents the first learning participant's country of origin, ethnicity, or region; and a process of providing a conversational text including at least two sentences in a role-playing format using the pronunciation content corresponding to the sentence.

According to some example embodiments, it is possible to construct pronunciation content recorded by a user having a corresponding accent into a database for each accent and to provide a conversation learning platform using the database.

According to some example embodiments, it is possible to provide a service that allows a user to record or listen to pronunciation content for a conversational text on a topic selected by the user in a role-playing format.

According to some example embodiments, it is possible to provide user experience in a form in which a user having an accent selected by a user appears as a counterpart of a role-playing conversation and converses with the user.

According to some example embodiments, it is possible to expand a conversation tree through participation in free talking and to generate a conversational text in various scenarios.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

Example embodiments will be described in more detail with regard to the figures, wherein like reference numerals refer to like parts throughout the various figures unless otherwise specified, and wherein:

FIG. 1 is a diagram illustrating an example of a network environment according to at least one example embodiment;

FIG. 2 is a diagram illustrating an example of a computer device according to at least one example embodiment;

FIG. 3 is a flowchart illustrating an example of a method of providing an audio participation service for collecting pronunciation content for each accent according to at least one example embodiment;

FIG. 4 illustrates an example of a service screen for setting an accent of a learning participant according to at least one example embodiment;

FIGS. 5 to 7 illustrate examples of a service screen for registering pronunciation content according to at least one example embodiment;

FIG. 8 illustrates an example of a service screen for displaying pronunciation content according to at least one example embodiment;

FIG. 9 illustrates an example of a personal profile screen according to at least one example embodiment;

FIG. 10 is a flowchart illustrating an example of a method of providing a conversational text for language learning in a role-playing format according to at least one example embodiment;

FIGS. 11 and 12 illustrate examples of a service screen for selecting a language learning topic according to at least one example embodiment;

FIGS. 13 to 18 illustrate examples of describing a role-playing conversation learning process according to at least one example embodiment; and

FIGS. 19 and 20 illustrate examples of describing a conversation tree expansion process according to at least one example embodiment.

It should be noted that these figures are intended to illustrate the general characteristics of methods and/or structure utilized in certain example embodiments and to supplement the written description provided below. These drawings are not, however, to scale and may not precisely reflect the precise structural or performance characteristics of any given embodiment, and should not be interpreted as defining or limiting the range of values or properties encompassed by example embodiments.

### DETAILED DESCRIPTION OF THE INVENTION

One or more example embodiments will be described in detail with reference to the accompanying drawings. Example embodiments, however, may be embodied in various different forms, and should not be construed as being limited to only the illustrated embodiments. Rather, the illustrated embodiments are provided as examples so that this disclosure will be thorough and complete, and will fully convey the concepts of this disclosure to those skilled in the art. Accordingly, known processes, elements, and techniques, may not be described with respect to some example embodiments. Unless otherwise noted, like reference characters denote like elements throughout the attached drawings and written description, and thus descriptions will not be repeated.

Although the terms “first,” “second,” “third,” etc., may be used herein to describe various elements, components, regions, layers, and/or sections, these elements, components, regions, layers, and/or sections, should not be limited by these terms. These terms are only used to distinguish one element, component, region, layer, or section, from another region, layer, or section. Thus, a first element, component, region, layer, or section, discussed below may be termed a second element, component, region, layer, or section, without departing from the scope of this disclosure.

Spatially relative terms, such as “beneath,” “below,” “lower,” “under,” “above,” “upper,” and the like, may be used herein for ease of description to describe one element or feature's relationship to another element(s) or feature (s) as illustrated in the figures. It will be understood that the spatially relative terms are intended to encompass different orientations of the device in use or operation in addition to the orientation depicted in the figures. For example, if the device in the figures is turned over, elements described as “below,” “beneath,” or “under,” other elements or features would then be oriented “above” the other elements or features. Thus, the example terms “below” and “under” may encompass both an orientation of above and below. The device may be otherwise oriented (rotated 90 degrees or at other orientations) and the spatially relative descriptors used herein interpreted accordingly. In addition, when an element is referred to as being “between” two elements, the element may be the only element between the two elements, or one or more other intervening elements may be present.

As used herein, the singular forms “a,” “an,” and “the,” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups, thereof. As used herein, the term “and/or” includes any and all combinations of one or more of the associated listed products. Expressions such as “at least one of,” when preceding a list of elements, modify the entire list of elements and do not modify the individual elements of the list. Also, the term “exemplary” is intended to refer to an example or illustration.

When an element is referred to as being “on,” “connected to,” “coupled to,” or “adjacent to,” another element, the element may be directly on, connected to, coupled to, or adjacent to, the other element, or one or more other intervening elements may be present. In contrast, when an element is referred to as being “directly on,” “directly connected to,” “directly coupled to,” or “immediately adjacent to,” another element there are no intervening elements present.

Unless otherwise defined, all terms (including technical and scientific terms) used herein have the same meaning as commonly understood by one of ordinary skill in the art to which example embodiments belong. Terms, such as those defined in commonly used dictionaries, should be interpreted as having a meaning that is consistent with their meaning in the context of the relevant art and/or this disclosure, and should not be interpreted in an idealized or overly formal sense unless expressly so defined herein.

Example embodiments may be described with reference to acts and symbolic representations of operations (e.g., in the form of flow charts, flow diagrams, data flow diagrams, structure diagrams, block diagrams, etc.) that may be implemented in conjunction with units and/or devices discussed in more detail below. Although discussed in a particular manner, a function or operation specified in a specific block may be performed differently from the flow specified in a flowchart, flow diagram, etc. For example, functions or operations illustrated as being performed serially in two consecutive blocks may actually be performed simultaneously, or in some cases be performed in reverse order.

Units and/or devices according to one or more example embodiments may be implemented using hardware and/or a combination of hardware and software. For example, hardware devices may be implemented using processing circuitry such as, but not limited to, a processor, Central Processing Unit (CPU), a controller, an arithmetic logic unit (ALU), a digital signal processor, a microcomputer, a field programmable gate array (FPGA), a System-on-Chip (SoC), a programmable logic unit, a microprocessor, or any other device capable of responding to and executing instructions in a defined manner.

Software may include a computer program, program code, instructions, or some combination thereof, for independently or collectively instructing or configuring a hardware device to operate as desired. The computer program and/or program code may include program or computer-readable instructions, software components, software modules, data files, data structures, and/or the like, capable of being implemented by one or more hardware devices, such as one or more of the hardware devices mentioned above. Examples of program code include both machine code produced by a compiler and higher level program code that is executed using an interpreter.

For example, when a hardware device is a computer processing device (e.g., a processor), Central Processing Unit (CPU), a controller, an arithmetic logic unit (ALU), a digital signal processor, a microcomputer, a microprocessor, etc., the computer processing device may be configured to carry out program code by performing arithmetical, logical, and input/output operations, according to the program code. Once the program code is loaded into a computer processing device, the computer processing device may be programmed to perform the program code, thereby transforming the computer processing device into a special purpose computer processing device. In a more specific example, when the program code is loaded into a processor, the processor becomes programmed to perform the program code and operations corresponding thereto, thereby transforming the processor into a special purpose processor.

Software and/or data may be embodied permanently or temporarily in any type of machine, component, physical or virtual equipment, or computer storage medium or device, capable of providing instructions or data to, or being interpreted by, a hardware device. The software also may be distributed over network coupled computer systems so that the software is stored and executed in a distributed fashion. In particular, for example, software and data may be stored by one or more computer readable storage mediums, including the tangible or non-transitory computer-readable storage media discussed herein.

According to one or more example embodiments, computer processing devices may be described as including various functional units that perform various operations and/or functions to increase the clarity of the description. However, computer processing devices are not intended to be limited to these functional units. For example, in one or more example embodiments, the various operations and/or functions of the functional units may be performed by other ones of the functional units. Further, the computer processing devices may perform the operations and/or functions of the various functional units without sub-dividing the operations and/or functions of the computer processing units into these various functional units.

Units and/or devices according to one or more example embodiments may also include one or more storage devices. The one or more storage devices may be tangible or non-transitory computer-readable storage media, such as random access memory (RAM), read only memory (ROM), a permanent mass storage device (such as a disk drive, solid state (e.g., NAND flash) device, and/or any other like data storage mechanism capable of storing and recording data. The one or more storage devices may be configured to store computer programs, program code, instructions, or some combination thereof, for one or more operating systems and/or for implementing the example embodiments described herein. The computer programs, program code, instructions, or some combination thereof, may also be loaded from a separate computer readable storage medium into the one or more storage devices and/or one or more computer processing devices using a drive mechanism. Such separate computer readable storage medium may include a Universal Serial Bus (USB) flash drive, a memory stick, a Blue-ray/DVD/CD-ROM drive, a memory card, and/or other like computer readable storage media. The computer programs, program code, instructions, or some combination thereof, may be loaded into the one or more storage devices and/or the one or more computer processing devices from a remote data storage device via a network interface, rather than via a local computer readable storage medium. Additionally, the computer programs, program code, instructions, or some combination thereof, may be loaded into the one or more storage devices and/or the one or more processors from a remote computing system that is configured to transfer and/or distribute the computer programs, program code, instructions, or some combination thereof, over a network. The remote computing system may transfer and/or distribute the computer programs, program code, instructions, or some combination thereof, via a wired interface, an air interface, and/or any other like medium.

The one or more hardware devices, the one or more storage devices, and/or the computer programs, program code, instructions, or some combination thereof, may be specially designed and constructed for the purposes of the example embodiments, or they may be known devices that are altered and/or modified for the purposes of example embodiments.

A hardware device, such as a computer processing device, may run an operating system (OS) and one or more software applications that run on the OS. The computer processing device also may access, store, manipulate, process, and create data in response to execution of the software. For simplicity, one or more example embodiments may be exemplified as one computer processing device; however, one skilled in the art will appreciate that a hardware device may include multiple processing elements and multiple types of processing elements. For example, a hardware device may include multiple processors or a processor and a controller. In addition, other processing configurations are possible, such as parallel processors.

Although described with reference to specific examples and drawings, modifications, additions and substitutions of example embodiments may be variously made according to the description by those of ordinary skill in the art. For example, the described techniques may be performed in an order different with that of the methods described, and/or components such as the described system, architecture, devices, circuit, and the like, may be connected or combined to be different from the above-described methods, or results may be appropriately achieved by other components or equivalents.

Hereinafter, some example embodiments will be described with reference to the accompanying drawings.

The example embodiments relate to technology for providing a conversational text for language learning.

The example embodiments including disclosures herein may provide a conversational text for language learning in a role-playing conversation format.

A conversation learning service system according to the example embodiments may be implemented by at least one computer device and a conversation learning service method according to the example embodiments may be performed by the at least one computer device included in the conversation learning service system. Here, a computer program according to an example embodiment may be installed and executed on the computer device, and the computer device may perform the conversation learning service method according to the example embodiments under the control of the executed computer program. The aforementioned computer program may be stored in a computer-readable storage medium to computer-implement the conversation learning service method in conjunction with the computer device.

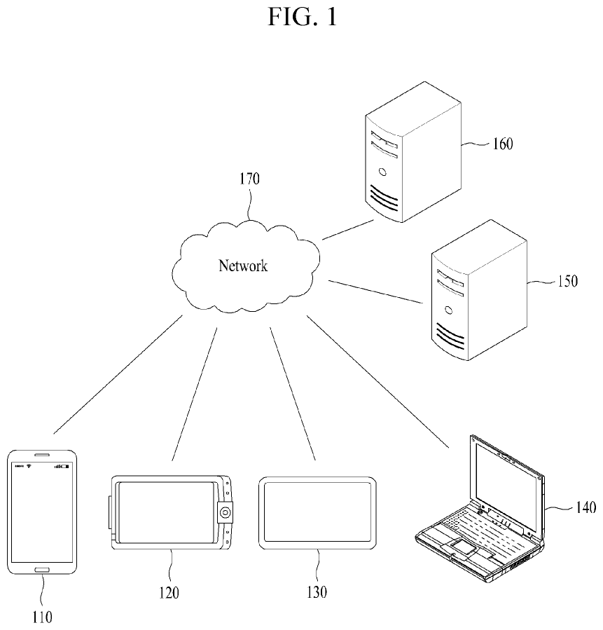

FIG. 1 illustrates an example of a network environment according to at least one example embodiment. Referring to FIG. 1, the network environment may include a plurality of electronic devices 110, 120, 130, and 140, a plurality of servers 150 and 160, and a network 170. FIG. 1 is provided as an example only. The number of electronic devices or the number of servers is not limited thereto. Also, the network environment of FIG. 1 is provided as an example among environments applicable to the example embodiments and the environment applicable to the example embodiments is not limited to the network environment of FIG. 1.

Each of the plurality of electronic devices 110, 120, 130, and 140 may be a fixed terminal or a mobile terminal that is configured as a computer device. For example, the plurality of electronic devices 110, 120, 130, and 140 may be a smartphone, a mobile phone, a navigation device, a computer, a laptop computer, a digital broadcasting terminal, a personal digital assistant (PDA), a portable multimedia player (PMP), a tablet personal computer (PC), and the like. For example, although FIG. 1 illustrates a shape of a smartphone as an example of the electronic device 110, the electronic device 110 used herein may refer to one of various types of physical computer devices capable of communicating with other electronic devices 120, 130, and 140, and/or the servers 150 and 160 over the network 170 in a wireless or wired communication manner.

The communication scheme is not limited and may include a near field wireless communication scheme between devices as well as a communication scheme using a communication network (e.g., a mobile communication network, wired Internet, wireless Internet, a broadcasting network, etc.) includable in the network 170. For example, the network 170 may include at least one of network topologies that include a personal area network (PAN), a local area network (LAN), a campus area network (CAN), a metropolitan area network (MAN), a wide area network (WAN), a broadband network (BBN), and the Internet. Also, the network 170 may include at least one of network topologies that include a bus network, a star network, a ring network, a mesh network, a star-bus network, a tree or hierarchical network, and the like. However, they are provided as examples only.

Each of the servers 150 and 160 may be configured as a computer device or a plurality of computer devices that provides an instruction, a code, a file, content, a service, etc., through communication with the plurality of electronic devices 110, 120, 130, and 140 over the network 170. For example, the server 150 may be a system that provides a service (e.g., a conversation learning service) to the plurality of electronic devices 110, 120, 130, and 140 connected over the network 170.

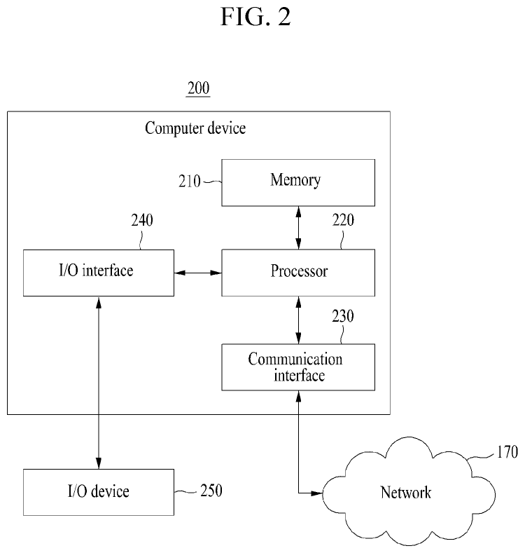

FIG. 2 is a block diagram illustrating an example of a computer device according to at least one example embodiment. Each of the plurality of electronic devices 110, 120, 130, and 140 of FIG. 1 or each of the servers 150 and 160 may be implemented by a computer device 200 of FIG. 2.

Referring to FIG. 2, the computer device 200 may include a memory 210, a processor 220, a communication interface 230, and an input/output (I/O) interface 240. The memory 210 may include a permanent mass storage device, such as a random access memory (RAM), a read only memory (ROM), and a disk drive, as a non-transitory computer-readable record medium. The permanent mass storage device, such as ROM and a disk drive, may be included in the computer device 200 as a permanent storage device separate from the memory 210. Also, an OS and at least one program code may be stored in the memory 210. Such software components may be loaded to the memory 210 from another non-transitory computer-readable record medium separate from the memory 210. The other non-transitory computer-readable record medium may include a non-transitory computer-readable record medium, for example, a floppy drive, a disk, a tape, a DVD/CD-ROM drive, a memory card, etc. According to other example embodiments, software components may be loaded to the memory 210 through the communication interface 230, instead of the non-transitory computer-readable record medium. For example, the software components may be loaded to the memory 210 of the computer device 200 based on a computer program installed by files received over the network 170.

The processor 220 may be configured to process instructions of a computer program by performing basic arithmetic operations, logic operations, and I/O operations. The computer-readable instructions may be provided from the memory 210 or the communication interface 230 to the processor 220. For example, the processor 220 may be configured to execute received instructions in response to the program code stored in the storage device, such as the memory 210.

The communication interface 230 may provide a function for communication between the communication apparatus 200 and another apparatus, for example, the aforementioned storage devices. For example, the processor 220 of the computer device 200 may forward a request or an instruction created based on a program code stored in the storage device such as the memory 210, data, and a file, to other apparatuses over the network 170 under control of the communication interface 230. Inversely, a signal, an instruction, data, a file, etc., from another apparatus may be received at the computer device 200 through the communication interface 230 of the computer device 200. For example, a signal, an instruction, content, data, etc., received through the communication interface 230 may be forwarded to the processor 220 or the memory 210, and a file, etc., may be stored in a storage medium, for example, the permanent storage device, further includable in the computer device 200.

The I/O interface 240 may be a device used for interfacing with an I/O device 250. For example, an input device of the I/O device 250 may include a device, such as a microphone, a keyboard, a mouse, etc., and an output device of the I/O device 250 may include a device, such as a display, a speaker, etc. As another example, the I/O interface 240 may be a device for interfacing with an apparatus in which an input function and an output function are integrated into a single function, such as a touchscreen. The I/O device 250 may be configured as a single apparatus with the computer device 200.

According to other example embodiments, the computer device 200 may include greater or less number of components than those shown in FIG. 2. For example, the computer device 200 may include at least a portion of the I/O device 250, or may further include other components, for example, a transceiver, a database, etc.

Hereinafter, example embodiments of a method and a device for providing conversational content in a role-playing format are described in detail.

The computer device 200 according to the example embodiment may provide a conversation learning service through connection to a dedicated application installed on a client or a website/mobile site related to the computer device 200 to the client. A computer-implemented conversation learning service system may be configured in the computer device 200. For example, the conversation learning service system may be implemented in a form of a program that independently operates or may be configured in a in-app form of a specific application to be operable on the specific application.

The processor 220 of the computer device 200 may be implemented as a component for performing the following conversation learning service method. Depending on example embodiments, components of the processor 220 may be selectively included in or excluded from the processor 220. Also, depending on example embodiments, components of the processor 220 may be separated or merged for functional expression of the processor 220.

The processor 220 and components of the processor 220 may control the computer device 200 to perform operations included in the following conversation learning service method. For example, the processor 220 and components of the processor 220 may be implemented to execute instructions according to a code of at least one program and a code of an OS included in the memory 210.

Here, the components of the processor 220 may be representations of different functions performed by the processor 220 in response to an instruction provided from a program code stored in the computer device 200.

The processor 220 may read a necessary instruction from the memory 210 to which instructions related to control of the computer device 200 are loaded. In this case, the read instruction may include an instruction for controlling the processor 220 to perform the following operations.

The following operations may be performed in order different from the illustrated order and some of the operations may be omitted or an additional process may be further included.

A conversation learning service according to an example embodiment may be implemented as a function included in an audio participation service that collects and provides pronunciation content by various accents of each language through audio participation.

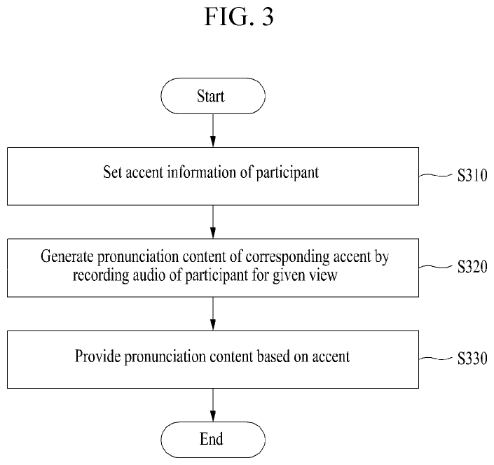

FIG. 3 is a flowchart illustrating an example of a method of providing an audio participation service for collecting pronunciation content for each accent according to at least one example embodiment.

Referring to FIG. 3, in operation S310, the processor 220 may set accent information of a participant for each learning participant through participant setting. The accent information refers to language information used in the participant's country of origin, ethnicity, or region. For example, the processor 220 may set a language mainly used by the participant, such as the mother tongue, i.e., native language, as accent information. In the example embodiment, pronunciation for each accent may be collected for the same word or sentence in consideration of the fact that accents differ depending on the country of origin or region even in the same language. To this end, the processor 220 may set the mother tongue mainly used by a corresponding participant as accent information of a learning participant that desires to participate in pronunciation collection.

In operation S320, the processor 220 may generate pronunciation content by recording audio uttered by the participant for a given view of text displayed on a screen. The processor 220 may randomly select a word, an idiom, a sentence, and the like, in the dictionary using a dictionary database and may provide the same as a view on a screen. The processor 220 may generate pronunciation content in the corresponding accent by tagging and storing accent information of the corresponding participant in an audio recording of the participant for the view of the text. Here, the processor 220 may store and manage demographic information (e.g., age, gender, occupation, etc.) of the corresponding participant by tagging the demographic information in the pronunciation content of the participant. For the pronunciation content of the participant, the processor 220 may tag demographic information and may also tag an original text provided as a view on a screen, and a type of the original text (e.g., word, idiom, sentence, etc.) and voice tone information or topic information designated by the participant. Information tagged in the pronunciation content may be used as a filter condition to select and provide pronunciation content. Also, the processor 220 may perform inspection on an audio recording of the participant and may filter the pronunciation content according to an inspection result. The processor 220 may filter the pronunciation content based on a voice recognition result, a sound quality evaluation result such as a sound level, and the like, with respect to the participant's audio.

In operation S330, the processor 220 may provide the pronunciation content based on an accent. For example, when a specific accent is selected, the processor 220 may provide a playlist that includes pronunciation content in the corresponding specific accent. As another example, the processor 220 may provide a playlist that includes pronunciation content of a specific view type such as a word, an idiom, and a sentence, as a filter condition. As another example, the processor 220 may provide a playlist that includes pronunciation content of a specific demographic by using demographic information, such as an age, a gender, and an occupation of a learning participant, as a filter condition. As another example, the processor 220 may provide a playlist that includes pronunciation content of a corresponding tone of voice or topic by using tone information or topic information as a filter condition. Here, the processor 220 may sort a pronunciation content playlist based on content generation time, the cumulative number of playbacks, positive responses (e.g., likes), the cumulative number of sharing, and the like.

The processor 220 may display pronunciation content through a screen on an electronic device 110, 120, 130 or 140 through an audio participation service, and may also provide pronunciation content through a service area of another platform linkable with the audio participation service, for example, a dictionary platform that provides a language dictionary and a language learning service. The processor 220 may display the pronunciation content in association with the language dictionary or language learning within the dictionary platform. Here, the processor 220 may support synchronization with a dictionary platform for related data, such as playback, positive response, and sharing of the pronunciation content.

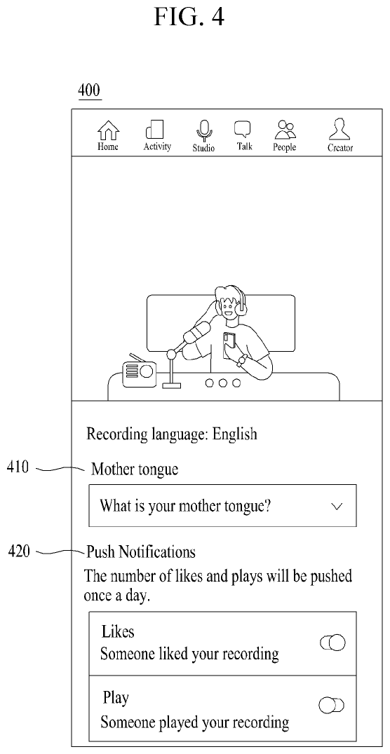

FIG. 4 illustrates an example of a service screen on an electronic device 110, 120, 130 or 140 for setting an accent of a learning participant according to at least one example embodiment. FIG. 4 illustrates a setting screen 400 for a service user to sign up as a learning participant.

Referring to FIG. 4, the setting screen 400 may include an accent interface for setting accent information of the learning participant. Depending on example embodiments, the setting screen 400 may include an interface 410 for directly setting a target language to participate in an audio recording for pronunciation collection. For example, with the assumption that user A is from Canada, accent information of user A may be set to Canada and a target language to participate in an audio recording may be set to English.

The setting screen 400 may include a ‘push notification’ interface 420 for setting a push notification allow status. The push notification refers to periodic information related to pronunciation content of the learning participant and may provide, for example, the cumulative number of playbacks and user response information such as the cumulative number of positive responses with respect to pronunciation content generated by the learning participant. The ‘push notification’ interface 420 may be configured as an interface capable of selectively setting a notification reception allow status according to an information type.

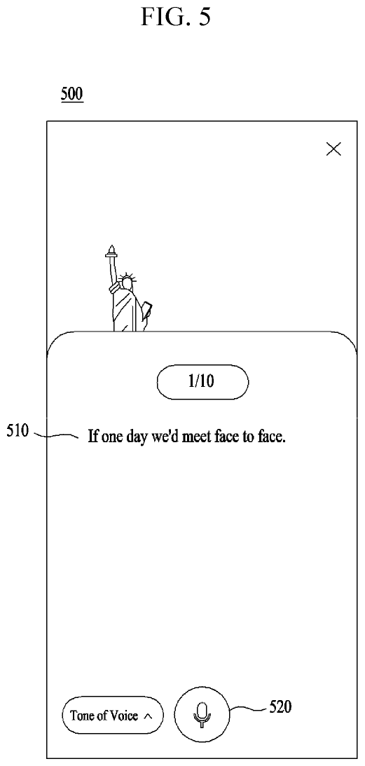

FIGS. 5 to 7 illustrate examples of a service screen on an electronic devices 110, 120, 130 or 140 for registering pronunciation content according to at least one example embodiment. FIGS. 5 to 7 illustrate a pronunciation registration screen 500.

Referring to FIG. 5, the processor 220 may provide a view 510 (i.e., a display of a text) for pronunciation collection through the pronunciation registration screen 500. The view 510 may be provided in units of sets. For example, 10 views corresponding to words, idioms, and sentences may be provided as a single set.

The pronunciation registration screen 500 may include a recording interface 520 for recording audio of a participant that reads the view 510. The processor 220 may record the participant's audio while sequentially providing a single set of views 510.

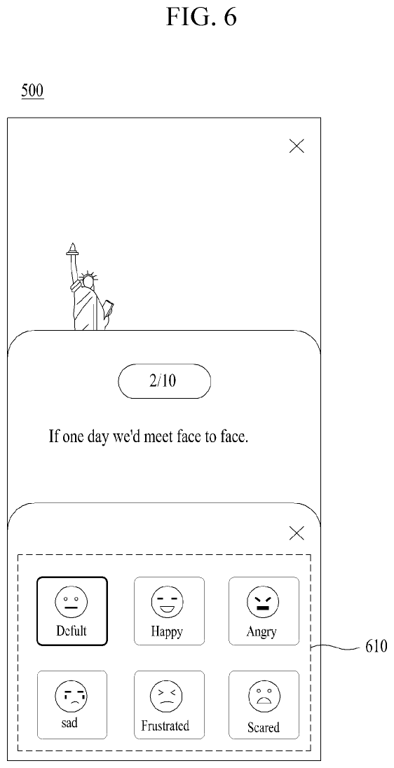

Here, the processor 220 may set tone-of-voice information prior to recording the participant's audio. Referring to FIG. 6, the processor 220 may provide a list of voice tones (e.g., Default, Happy, Angry, Sad, Frustrated, Scared, etc.) 610 settable through the pronunciation registration screen 500. When recording, the recording may be performed after designating a tone of voice. For example, when the view 510 relates to happy content, the recording may be performed after selecting ‘Happy’ from the list of tones 610. The participant may directly set a tone of voice for recording the participant's audio through the list of tones 610. Also, the processor 220 may recommend a suitable tone of voice according to the content of the view 510.

The processor 220 may provide the view 510 of a topic area designated by the participant to collect pronunciation content by topic area. The processor 220 may provide a list of topics through the pronunciation registration screen 500 prior to recording the participant's audio and may provide the view 510 of a topic selected from the topic list and may collect pronunciation content of the corresponding topic.

The processor 220 may provide dictionary information on words included in the view 510. When a specific word is selected from the view 510, the processor 220 may display dictionary information that includes the meaning and the pronunciation of the corresponding specific word through an interface, such as a pop-up.

In addition to providing the dictionary information, the processor 220 may also provide at least one translation of the view 510. In response to a request from the participant, the processor 220 may provide a translation result acquired by translating the view 510 into a language designated by the participant or at least one predetermined language.

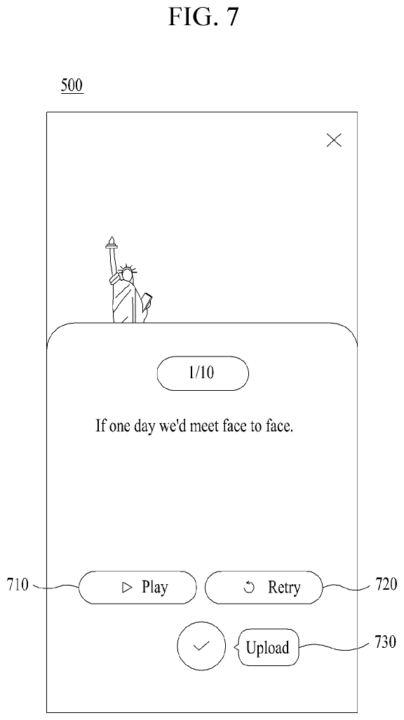

Referring to FIG. 7, when the participant completes the audio recording for the view 510 using the recording interface 520, the processor 220 may activate a play interface 710 for playing back the recorded audio, a retry interface 720 for re-recording the audio, and an upload interface 730 for uploading the recorded audio through the pronunciation registration screen 500.

When the participant requests uploading of the recorded audio through the upload interface 730, the processor 220 may receive the corresponding participant's audio and may perform audio inspection.

When a match rate between a text extracted from the participant's audio and an original text of the view 510 is significantly low or when too much noise is mixed in the participant's audio as a result of the audio inspection, the processor 220 may request again the audio recording of the view 510 to the participant through a pop-up on the pronunciation registration screen 500.

The processor 220 may collect and register the participant's audio for the view 510 as pronunciation content through interaction with the participant that uses the pronunciation registration screen 500.

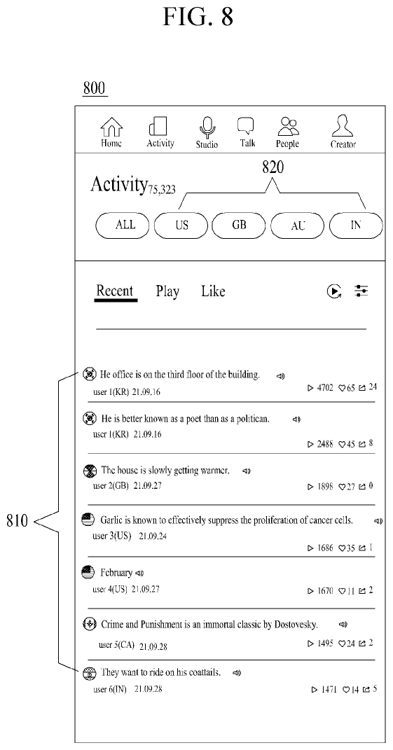

FIG. 8 illustrates an example of a service screen on an electronic devices 110, 120, 130 or 140 for displaying pronunciation content according to at least one example embodiment. FIG. 8 illustrates an audio participation service screen 800 that is a self-display area of an audio participation service.

Referring to FIG. 8, the processor 220 may display a pronunciation content list 810 through the audio participation service screen 800.

The processor 220 may display the pronunciation content list 810 by classifying the same by the accent 820 of a learning participant that generated the corresponding pronunciation content.

The processor 220 may sort and display the pronunciation content list 810 based on content generation time, the cumulative number of playbacks, the cumulative number of positive responses, and the cumulative number of sharing.

The processor 220 may provide a detailed search for the pronunciation content list 810 using view types (e.g., word, idiom, sentence, etc.) or demographics (e.g., age, gender, occupation, etc.).

The processor 220 may support playback of the entire pronunciation content list 810 or may support selective individual playback of each piece of pronunciation content.

The processor 220 may provide an interface capable of inputting a positive response (e.g., like) for each piece of pronunciation content included in the pronunciation content list 810 as well as for the entire pronunciation content list 810, an interface capable of sharing each piece of pronunciation content, and an interface capable of accessing a profile screen of a learning participant.

The processor 220 may display the cumulative number of playbacks, the cumulative number of positive responses, and the cumulative number of sharing for each pronunciation content included in the pronunciation content list 810 with the pronunciation content list 810.

The processor 220 may display tone-of-voice information or topic information set during recording for each pronunciation content included in the pronunciation content list 810.

The processor 220 may provide a push notification to a learning participant that allows a notification reception based on a user response (e.g., cumulative number of playbacks, cumulative number of responses, etc.) to pronunciation content of a corresponding learning participant. For example, the processor 220 may collect a user response to pronunciation content of a learning participant on a daily basis and may provide a push notification for a collection result once a day.

Also, the processor 220 may provide pronunciation content of another participant to which a corresponding learning participant sets a subscription through a subscription function. For example, the processor 220 may support a follow-based subscription relationship between users that use an audio participation service. For example, with the assumption that participant A subscribes to participant B, when participant B registers new pronunciation content, a notification for new content of participant B may be provided to participant A. The processor 220 may provide a corresponding participant with new content feeds of other participants to which the participant subscribes.

The processor 220 may induce continuous motivation and a revisit to a service through a push notification.

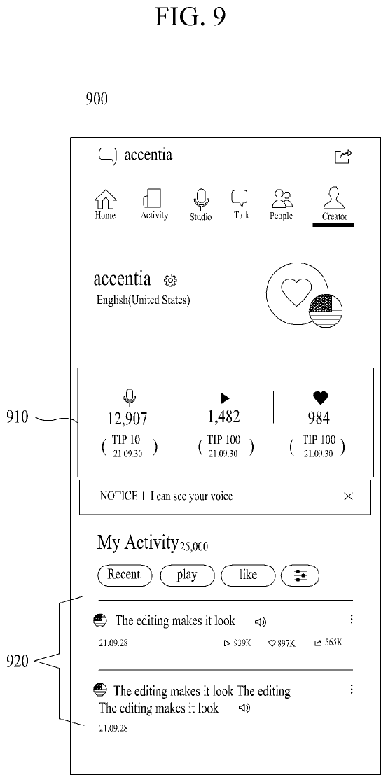

FIG. 9 illustrates an example of a personal profile screen on an electronic devices 110, 120, 130 or 140 according to at least one example embodiment.

Referring to FIG. 9, the processor 220 may display activity information 910 of a learning participant through a personal profile screen 900. The activity information 910 may include the total number of possessed pronunciation contents, the cumulative total number of playbacks of the entire pronunciation contents, and the cumulative total number of positive responses of the entire pronunciation content, and may include the ranking for each pronunciation content.

The processor 220 may display a pronunciation content list 920 generated by a learning participant through the personal profile screen 900.

The processor 220 may sort and display the pronunciation content list 920 based on content generation time, the cumulative number of playbacks, the cumulative number of positive responses, and the cumulative number of sharing.

The processor 220 may display the cumulative number of playbacks, the cumulative number of positive responses, and the cumulative number of sharing for each pronunciation content included in the pronunciation content list 920 with the pronunciation content list 920.

The processor 220 may reinforce personal motivation by providing an activity history of the learning participant through the personal profile screen 900.

The personal profile screen 900 may include a space for appealing to learning participants through photos, introductions, and hashtags in addition to the activity information 910 and the pronunciation content list 920.

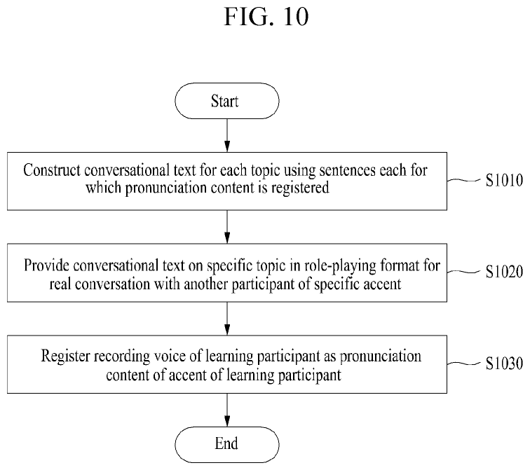

FIG. 10 is a flowchart illustrating an example of a method of providing a conversational text for language learning in a role-playing format according to at least one example embodiment.

Referring to FIG. 10, in operation S1010, the processor 220 may construct a conversational text for each topic using sentences each for which pronunciation content is registered through an audio participation service. The conversational text may refer to a set of sentences that include at least two sentences exchanged between at least two users according to a scenario of a predetermined topic. In a pronunciation content generation process, original text sentence, accent, topic, voice tone information, and registration date and time information may be tagged and thereby stored and managed. The processor 220 may construct a database by collecting pronunciation content for each of various accents of each language and may generate the conversational text that includes sentences of a corresponding topic for each topic using sentences for which pronunciation content is registered to the database. The processor 220 may generate a conversational text on a corresponding topic by combining sentences each for which pronunciation content is registered in association with a single topic. Here, the processor 220 may generate the conversational text in a linguistically more natural scenario using a language model. Various conversation topics may be designated by assuming various situations for language learning, such as visiting an airport, conversing about school life, inquiring about a hotel reservation, discussing current events, ordering from a restaurant menu, and the like, and the conversational text may be generated by combining sentences of a corresponding topic in predetermined order for each topic. Depending on example embodiments, a conversational text including a set of correct sentences may be predefined for each topic. That is, the processor 220 may generate a topic-specific conversational text using sentences for which pronunciation content may be registered through the audio participation service and may also provide a conversation learning service as text-based content regardless of the pronunciation content. Further, the processor 220 may generate a conversation tree through participation in free talking on each topic and then generate the conversational text in various scenarios from the conversation tree. Expansion of the conversation tree through participation in free talking is further described below.

In operation S1020, as a learning participant selects a specific topic as a language learning topic, the processor 220 may provide a conversational text on the corresponding specific topic in a role-playing format for conversation between participants. Here, the processor 220 may receive a selection on a specific accent desired to be learned from a learning participant and may designate at least one another participant (hereinafter, referred to as a “counterpart participant” having the selected specific accent as a counterpart for the conversational text. That is, the processor 220 may provide, as a counterpart role, a counterpart participant that registers pronunciation content in an accent selected by the learning participant with respect to sentences included in the conversational text. The processor 220 may also provide a counterpart participant directly selected by the learning participant as a counterpart role. The processor 220 may provide an experience in which the learning participant and the counterpart participant take their own roles and utter sentences included in the conversational text sentence by sentence. In the case of a sentence given to the counterpart participant, the processor 220 may play back pronunciation content that is registered by the counterpart participant for the corresponding sentence. Meanwhile, in the case of a sentence given to the learning participant, the processor 220 may proceed in an audio recording mode for requesting real-time utterance and recording audio uttered by the learning participant. The processor 220 may provide an experience in which the counterpart participant and the learning participant converse by repeating a process of playing back pronunciation content of the counterpart participant and a process of recording actual uttered voice of the learning participant with respect to each sentence that is given in sentence order of the conversational text. The learning participant may utter and record the sentence that is given as a single role of the conversational text. In the case of a sentence without pronunciation content being recorded by a participant among sentences included in the conversational text, corresponding pronunciation may be played back through text to speech (TTS).

In operation S1030, the processor 220 may generate and register an audio recording by the learning participant with respect to each sentence that is given to the learning participant among sentences included in the conversational text as pronunciation content in an accent used by a corresponding participant. Likewise, the processor 220 may tag and store an original text sentence and accent, a topic, and the like in pronunciation content generated by the learning participant. The processor 220 may provide a playback mode for the conversational text by accumulating audio recordings of the learning participant in a database for each accent, and may use the same when another counterpart appears. After role-playing through an audio recording mode of the learning participant is completed, the processor 220 may provide role-playing for the conversational text in a playback mode in which the pronunciation content of the learning participant is included. That is, in the playback mode, the experience of having a conversation may be implemented while sequentially playing back pronunciation content of the counterpart participant and pronunciation content of the learning participant with respect to each sentence that is given in sentence order of the conversational text.

The example embodiments may include a structure in which language expansion is easy, may implement an audio participation service for collecting pronunciation content by accent for each language, and may expand a service to major languages, such as Korean, Chinese, Japanese, and the like, by replacing the language of content for the conversation learning service, that is, the conversational text based on pronunciation content that is collected through the audio participation service.

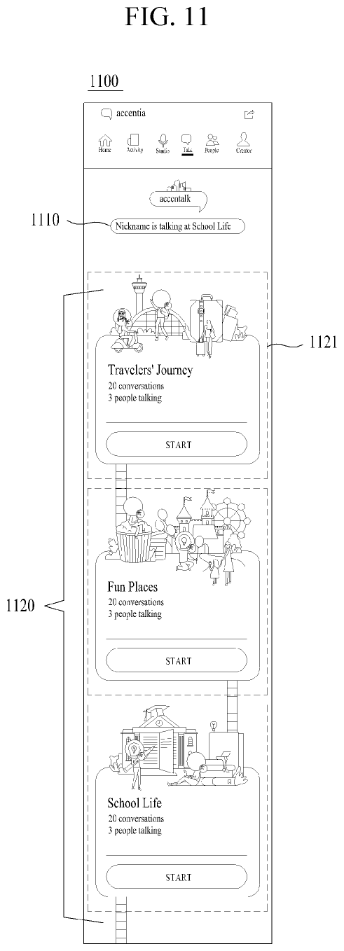

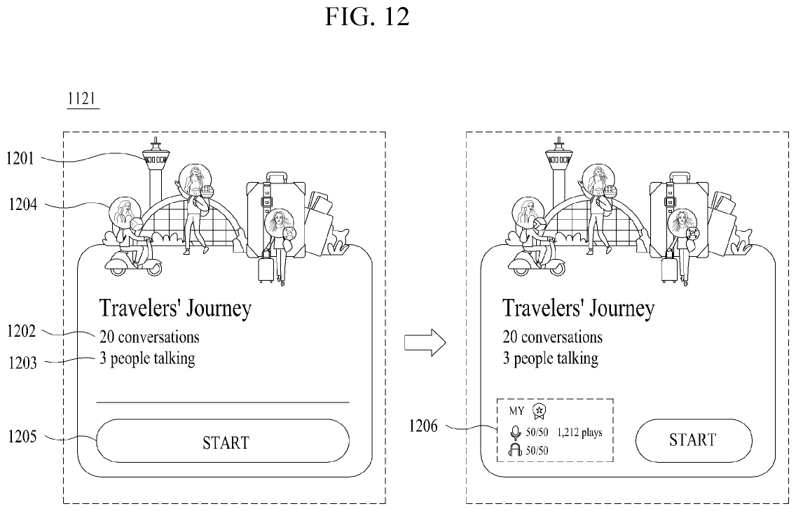

FIGS. 11 and 12 illustrate examples of a service screen on an electronic devices 110, 120, 130 or 140 for selecting a language learning topic according to at least one example embodiment.

FIG. 11 illustrates a main conversation learning screen 1100.

Referring to FIG. 11, the main conversation learning screen 1100 may include a recent state information 1110 of a learning participant, a topic list 1120 available for conversation learning, and the like.

The processor 220 may display a topic of a conversational text recently learned by the learning participant through the recent state information 1110. For example, when the learning participant completes a recording of a single set of conversational texts, a nickname and a recent language learning topic of the learning participant may be displayed as the recent state information 1110. In response to a selection on a nickname on the recent state information 1110, a mini profile screen (not shown) that includes the personal profile screen 900 or the activity information 910 may be displayed.

The learning participant may select a category of a situation that the learning participant desires to learn through the topic list 1120. The topic list 1120 may include topics available for language learning by configuring at least one conversational text and topic information 1121 may be displayed for each topic.

Referring to FIG. 12, the topic information 1121 may include a variety of information as a concept of a virtual space for a corresponding topic. For example, the topic information 1121 may include an object 1201 related to a corresponding topic, the number of conversational texts 1202 in the topic, the total number of participants 1203 that participate in recording a conversational text, participant profile information (e.g., profile image, accent image, etc.) 1204 of a recent participant that participates in recording the conversational text, and a start button 1205 for starting language learning. The participant profile information 1204 may be updated and displayed in real time based on profiles of recently participated participants (e.g., three participants) among the entire participants that participate in recording the conversational text of the corresponding topic.

The object 1201 may refer to a design element capable of representing a situation or a space corresponding to a topic and, for example, may use an image, such as an airport, an airplane, a suitcase, and a passport, for a travel, may use an image, such as popcorn, a balloon, and merry-go-round, for playing, and may use an image, such as a school, a pencil, a book, and a school cap, for school life.

For a topic having a participation history for conversational text recording, participation information 1206 of the learning participant may be displayed. The participation information 1206 may include, for example, the number of conversational texts of which recording the learning participant has participated in, the cumulative total number of playbacks of pronunciation content recorded by the learning participant with respect to sentences included in a conversational text, and the number of times the learning participant plays back the conversational text, as information on a recording behavior and a listening behavior of the learning participant. The recording behavior of the learning participant may include (1) content (individual sentence) recorded by the learning participant, (2) the number of times a recording file (pronunciation content) of (1) is played back, (3) the number of likes received for the recording file of (1), (4) the number of sets of conversational texts recorded by the learning participant for each topic, and (5) the number of times a file recorded by the learning participant in each topic is played back. The listening behavior of the learning participant may include (6) a conversational text the learning participant listens to, (7) the number of times the learning participant listens to the conversational text of (6), and (8) the number of times the learning participant listens to the conversational text in each topic. In the case of a topic having a participation history for conversational text recording, the number of conversational texts used for the learning participant to participate in language learning and the total number of playbacks thereof may be displayed based on a topic through the participation information 1206.

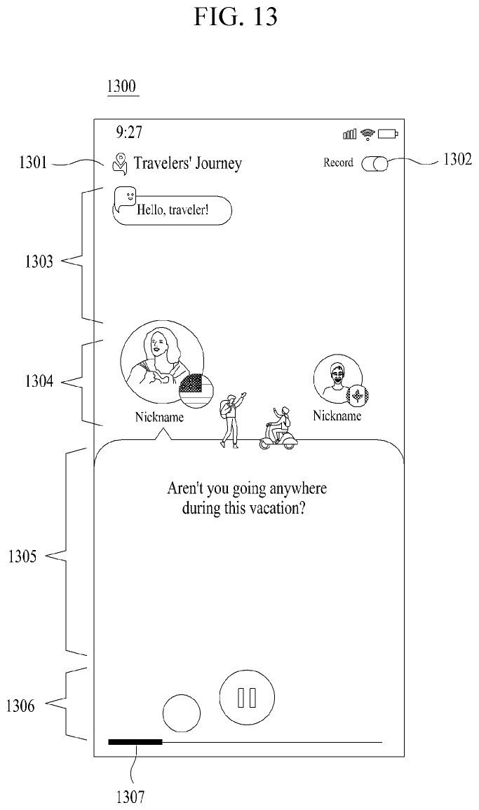

FIGS. 13 to 18 illustrate examples of describing a role-playing conversation learning process according to at least one example embodiment.

When a learning participant inputs the start button 1205 of a specific topic in the topic list 1120, the processor 220 may provide a role-playing conversation screen 1300 on an electronic devices 110, 120, 130 or 140 as illustrated in FIG. 13.

Referring to FIG. 13, the role-playing conversation screen 1300 may include topic information 1301, a mode button 1302, a content scrolling area 1303, a participant profile area 1304, an original text area 1305, a tool area 1306, and a progress bar 1307.

The topic information 1301 may display the topic of a current conversational text, that is, a language learning topic selected by the learning participant.

The mode button 1302 corresponds to a toggle button between an audio recording mode and a playback mode and may be provided in the audio recording mode in a default state. The mode may be changed for the same conversational text.

The content scrolling area 1303 refers to an area for displaying a guide message that guides a role-playing conversation and a content message that includes a sentence of which recording/playback is completed. The content scrolling area 1303 may be configured similarly to a chatroom interface for the experience of exchanging conversations between the learning participant and a counterpart participant. Sentences of which recordings/playbacks are completed may be displayed as message speech bubbles.

In the participant profile area 1304, profile information (e.g., profile image and accent image) of the learning participant and the counterpart participant may be displayed. For example, a profile of the counterpart participant may be displayed on the left and a profile of the learning participant may be displayed on the right.

In the original text area 1305, an original text sentence at a time of current recording or playback among sentences included in the conversational text may be displayed.

In the tool area 1306, an audio recording tool or a playback tool may be displayed according to a mode.

The progress bar 1307 relates to operating at a time of recording/playing back the conversational text and may represent a conversation progress according to recording/playback.

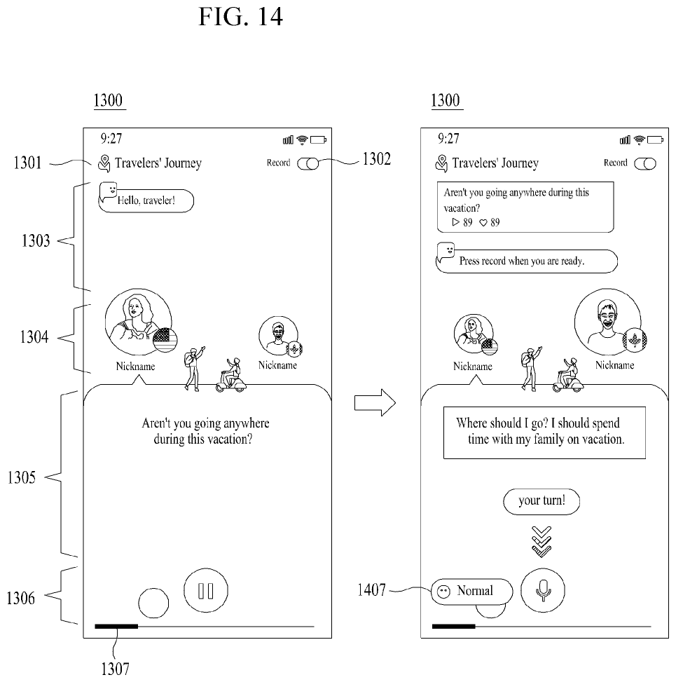

Referring to FIG. 14, the processor 220 may sequentially display sentences given to the learning participant and the counterpart participant among sentences included in the conversational text in the original text area 1305. In the audio recording mode, the playback tool may be displayed in the tool area 1306 for the counterpart participant's turn and the audio recording tool may be displayed in the tool area 1306 for the learning participant's turn.

In the learning participant's turn, the tool area 1306 may further include an emotion setting button 1407 for setting a tone of emotion with the audio recording tool. In response to the learning participant inputting the emotion setting button 1407, the list of settable tones 610 of FIG. 6 may be provided.

In displaying profile information in the participant profile area 1304, the processor 220 may highlight and thereby display profile information of a participant corresponding to the current turn over a counterpart using a display element, such as an image size and highlight. Through the participant profile area 1304, a profile image of an utterer that participates in a role-playing conversation may be displayed and the utterer's a dynamic motion may be provided, such as changing a profile image size or emphasizing an edge of a profile image.

The processor 220 may compare an original text and a text extracted from an audio recording of the learning participant through voice recognition technology and may determine whether a match rate between the extracted text and the original text is greater than or equal to a predetermined threshold. If the match rate between the text extracted through voice recognition and the original text is greater than or equal to the threshold, the processor 220 may store an audio recording of the learning participant as pronunciation content for a corresponding sentence. On the contrary, if the match rate between the text extracted through voice recognition and the original text is less than the threshold, the processor 220 may re-request the learning participant for audio recording.

The processor 220 may register an audio recording by the learning participant as pronunciation content in an accent used by the corresponding participant and may accumulate the same in a database for each accent. Audio recordings of the learning participant may be accumulated in the database for each accent and used in a playback mode for conversational text and may also be used for another participant to appear as a counterpart. The pronunciation content recorded by the learning participant through a role-playing conversation may be verified through a my-page area of the learning participant, for example, the pronunciation content list 920 of the personal profile screen 900.

The processor 220 may provide the conversational text in various combinations based on an accent using pronunciation content in the database for each accent and may implement a role-playing conversation (playback mode) in a combination of accents desired by the learning participant. The processor 220 may perform a role-playing conversation in which each of the learning participant and the counterpart participant takes on a role of the conversational text. Here, the processor 220 may provide a role interface for playing back pronunciation content of the counterpart participant and a role interface for recording an uttered voice of the learning participant with respect to sentences that are sequentially given in sentence order of the conversational text. Also, the processor 220 may proceed with the role-playing conversation in such a manner that each of counterpart participants with different accents takes on a single role based on a combination of accents desired by the learning participant. That is, the conversational text may be played back in such a manner that the learning participant does not directly participate in the role-playing conversation but may select a desired combination of other users for the roles in the role-playing conversation. For example, the learning participant may designate a user with an American accent for role A and a user with a Korean accent for role B.

The processor 220 may display a played back/recorded sentence in the conversational text as a message speech bubble in the content scrolling area 1303. Conversation content stacks of which playbacks/recordings are completed may be sequentially stacked and displayed.

Although a role-playing conversation in which two participants participate is described above, an experience in which three or more persons, each taking on a role, participating in a conversation may be provided.

In providing a list for a user to select a counterpart participant for the role-playing conversation, the processor 220 may provide a list of users having pronunciation content with respect to sentences of the conversational text. Here, the processor 220 may verify a log-in state for each user and then provide a list of users by distinguishing a user in a real-time access state from other users. Also, the processor 220 may provide a list of users having pronunciation content with respect to sentences of the conversational text among users having a relationship with the learning participant. For example, the learning participant may designate a counterpart participant by inviting a friend desired as a counterpart role from a friend list on the role-playing conversation screen 1300. Depending on example embodiments, the learning participant may verify information, such as pronunciation content and self-introduction of a corresponding participant, through a profile page of a specific participant. If the learning participant desires a conversation experience in the above process, a service may be provided in a form in which the learning participant enters and participates in a conversation recording already registered by the corresponding participant.

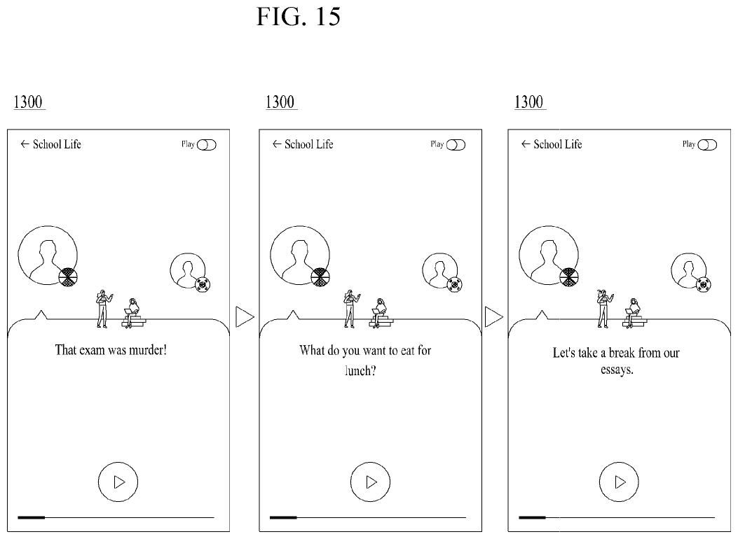

The processor 220 may provide a role-playing conversation in an environment in which various situations may be learned with respect to the same topic by sequentially providing a plurality of conversational texts on a single topic. For example, referring to FIG. 15, when the learning participant selects ‘school life’ as a language learning topic, the processor 220 may sequentially provide a conversational text in various situations, such as <test difficulty>, <lunch menu>, and <essay topic>, as sub-topics of ‘school life.’

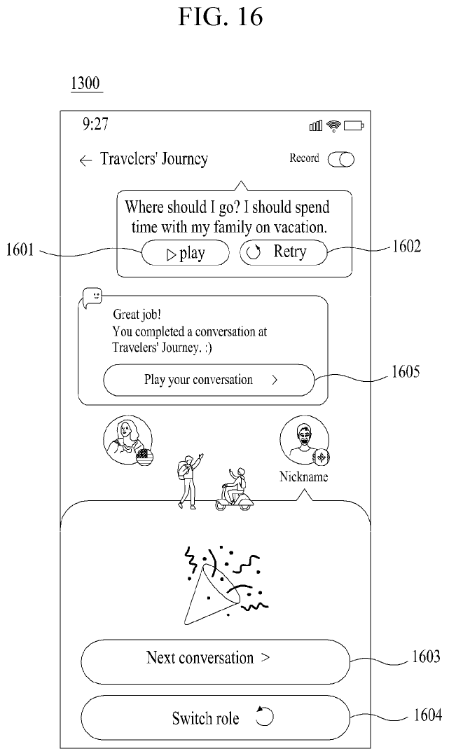

Referring to FIG. 16, a play button 1601 for playing back pronunciation content of a corresponding sentence in units of sentences in conversation contents stacked in the content scrolling area 1303 may be activated. The play button 1601 may be displayed for a sentence that is given to a counterpart participant and a retry button 1602 for recording audio may be displayed with the play button 1601.

When recording of a single set of conversational texts is completed, the processor 220 may activate and display, on the role-playing screen 1300, a next conversation button 1603 for proceeding with recording of another conversational text on the same topic and a switch role button 1604 for recording the recorded conversational text by switching roles between participants.

When recording of a single set of conversational texts is completed, the processor 220 may display, on the content scrolling area 1303, a guide message that includes a conversational text playback button 1605 for playing back pronunciation content of the entire sentences included in a corresponding conversational text, following a last message speech bubble.

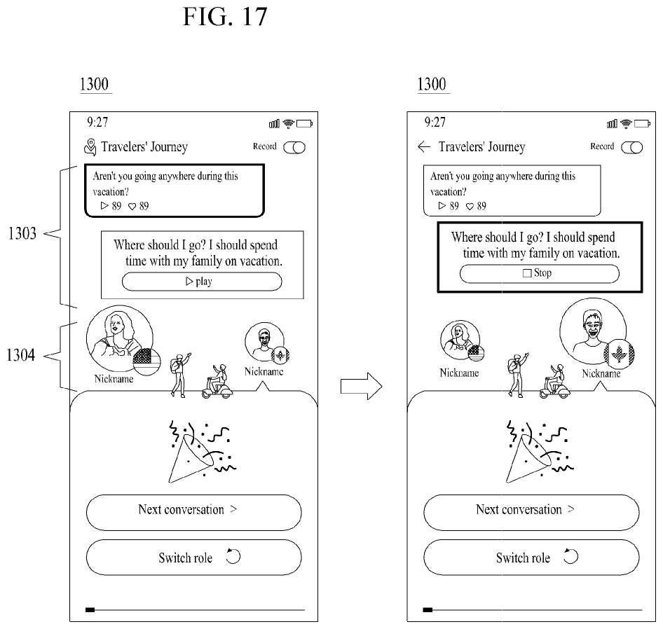

When the learning participant selects the conversational text playback button 1605 after the recording of a single set of conversational texts is completed, the processor 220 may perform a playback mode for the corresponding conversational text. As illustrated in FIG. 17, the processor 220 may sequentially play back pronunciation content of each sentence from a first sentence in units of sentences while automatically scrolling conversation contents stacked in the content scrolling area 1303. That is, in the playback mode, the processor 220 may implement the experience of having a conversation while sequentially playing back pronunciation content of the counterpart participant and pronunciation content of the learning participant with respect to each sentence that is given in sentence order of the conversational text.

Likewise, in the playback mode, the processor 220 may highlight and display profile information of a participant corresponding to the current turn over a profile of a counterpart in displaying profile information in the participant profile area 1304.

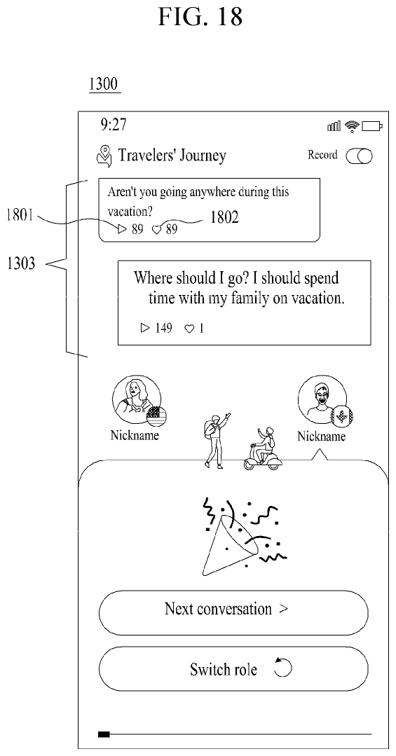

Referring to FIG. 18, when recording of a single set of conversational texts is completed, the processor 220 may activate and display a playback button 1801 for playing back pronunciation content of a corresponding sentence in units of sentences in conversation contents stacked in the content scrolling area 1303 and a feedback button 1802 for inputting a positive response (e.g., like).

The processor 220 may display the cumulative total number of playbacks and the cumulative total number of positive responses for pronunciation content in units of sentences in conversation contents stacked in the content scrolling area 1303.

Playback and feedback may be performed in units of sentences of the conversational text and, through this, the cumulative total number of playbacks and the cumulative total number of positive responses may be summed as activity information of an individual learning participant and may be used to determine a ranking or reward for each history.

The processor 220 may store and share a role-playing conversation process in which the learning participant participates as a multimedia product such as video and audio. For example, when recording of a single set of conversational texts is completed on the role-playing conversation screen 1300, the processor 220 may provide an interface capable of downloading the corresponding role-playing conversation process on the role-playing conversation screen 1300. As another example, the processor 220 may provide a list of conversations in which the learning participant participates through the personal profile screen 900 and may also provide an interface capable of downloading a corresponding role-playing conversation process for each of conversations included in a conversation list. In response to a request for downloading the role-playing conversation process in which the learning participant has participated, the processor 220 may store the corresponding role-playing conversation process in a storage space related to the learning participant through expert in a multimedia format or may share the same on another platform selected by the learning participant. When storing and sharing the role-playing conversation process, a service source may be included using a watermark, a voice, and a quick-response (QR) code.

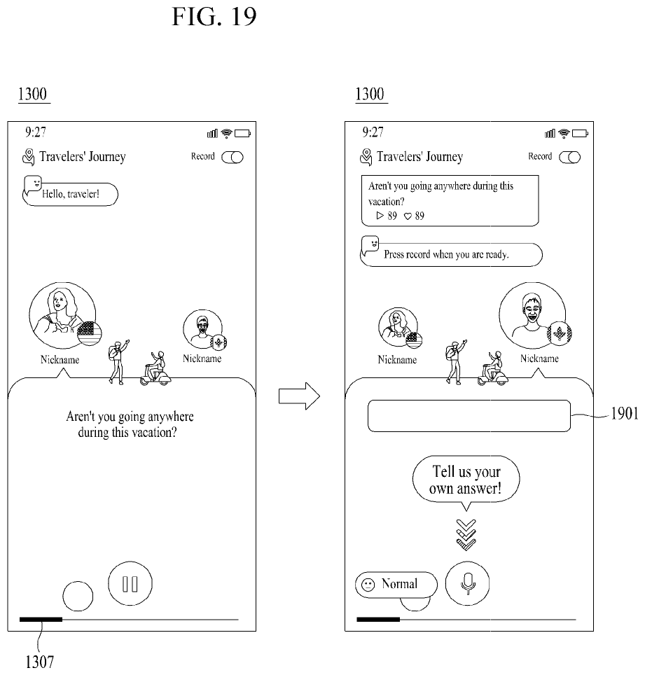

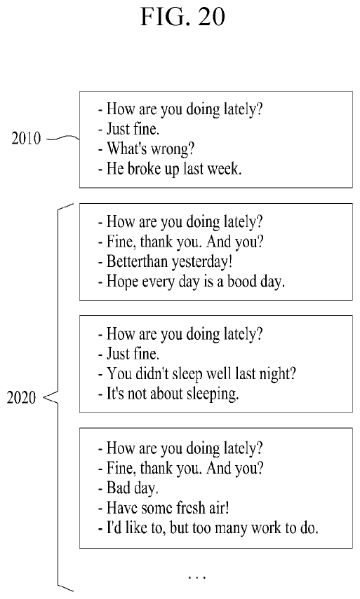

FIGS. 19 and 20 illustrate examples of describing a conversation tree expansion process according to at least one example embodiment.

The processor 220 may expand a database (e.g., an accent database according to an audio participation service, a conversational content database according to a conversation learning service, etc.) through free (i.e., unscripted) talking of a learning participant in a process of participating in a role-playing conversation. Referring to FIG. 19, in an audio recording mode, the processor 220 may play back pronunciation content registered in the accent of a counterpart participant with respect to a given sentence in the counterpart participant's turn and may activate and display a sentence input box 1901 for inputting a sentence the learning participant desires to add instead of the original text area 1305 in the learning participant's turn. The learning participant may proceed with an audio recording by inputting a sentence into the sentence input box 1901 and then uttering the corresponding sentence. Depending on example embodiments, a method in which the learning participant utters a sentence and the sentence is converted to a text using speech-to-text (STT) technology may also be applied. The processor 220 may provide a language learning environment in which the learning participant readily exchanges conversations through an interface capable of adding a new sentence to a default conversational text or uttering a sentence of the default conversational text with other contents.

The processor 220 may construct and provide a default conversational text for each topic and may generate a new conversational text based on a sentence added through participation in free talking. Referring to FIG. 20, the processor 220 may provide an interface that allows the learning participant to add a new sentence in a role-playing conversation participation process using a default conversational text 2010 and accordingly, may radially expand a conversation tree including sentences of the default conversational text 2010. The learning participant may proceed with a recording by directly adding a sentence to the default conversational text 2010. The processor 220 may generate a new conversational text 2020 in various scenarios based on the sentence added through the learning participant's participating in free talking.

According to some example embodiments, it is possible to construct pronunciation content recorded by a user having a corresponding accent into a database for each accent and to provide a conversation learning platform using the database. In particular, according to some example embodiments, it is possible to provide a service that allows a user to record or listen to pronunciation content of a conversational text on a topic selected by the user in a role-playing format. According to some example embodiments, it is possible to provide user experience in a form in which a person having an accent selected by a user appears as a counterpart of a role-playing conversation and converses with the user. According to some example embodiments, it is possible to expand a conversation tree through participation in free talking and to generate a conversational text in various scenarios.

The apparatuses described herein may be implemented using hardware components, software components, and/or a combination thereof. For example, the apparatuses and the components described herein may be implemented using one or more computers or processing devices, such as, for example, a processor, a controller, an arithmetic logic unit (ALU), a digital signal processor, a microcomputer, a field programmable gate array (FPGA), a programmable logic unit (PLU), a microprocessor or any other device capable of responding to and executing instructions in a defined manner. A processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciate that a processing device may include multiple processing elements and/or multiple types of processing elements. For example, a processing device may include multiple processors or a processor and a controller. In addition, different processing configurations are possible, such as parallel processors.

The software may include a computer program, a piece of code, an instruction, or some combinations thereof, for independently or collectively instructing or configuring the processing device to operate as desired. Software and/or data may be embodied permanently or temporarily in any type of machine, component, physical equipment, computer storage medium or device, or in a propagated signal wave capable of providing instructions or data to or being interpreted by the processing device. The software also may be distributed over network coupled computer systems so that the software is stored and executed in a distributed fashion. In particular, the software and data may be stored by one or more computer readable storage mediums.

The methods according to the example embodiments may be recorded in non-transitory computer-readable media including program instructions to implement various operations embodied by a computer. Here, the media may continuously store computer-executable programs or may transitorily store the same for execution or download. Also, the media may be various types of recording devices or storage devices in a form in which one or a plurality of hardware components are combined. Without being limited to media directly connected to a computer system, the media may be distributed over the network. Examples of non-transitory computer-readable media include magnetic media such as hard disks, floppy disks, and magnetic tapes; optical media such as CD ROM disks and DVD; magneto-optical media such as floptical disks; and hardware devices that are specially to store and perform program instructions, such as read-only memory (ROM), random access memory (RAM), flash memory, and the like. Examples of other media may include recording media and storage media managed by an app store that distributes applications or a site, a server, and the like that supplies and distributes other various types of software.

The foregoing description has been provided for purposes of illustration and description. It is not intended to be exhaustive or to limit the disclosure. Individual elements or features of a particular example embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A conversation learning service method executed on a computer device comprising at least one processor configured to execute computer-readable instructions included in a memory, the conversation learning service method comprising:
registering audio uttered by a first learning participant as pronunciation content in an accent that represents the first learning participant's country of origin, ethnicity, or region; and
providing a conversational text including at least two sentences in a role-playing format using the pronunciation content corresponding to the sentences.

2. The conversation learning service method of claim 1, wherein the conversational text is on a specific topic selected by a second learning participant in a role-playing format using pronunciation content in a specific accent selected by the second learning participant.

3. The conversation learning service method of claim 1, wherein the providing of the conversational text in the role-playing format comprises providing a first role interface for playing back the pronunciation content and a second role interface for recording uttered voice of a second learning participant with respect to the sentences that are sequentially given in a sentence order of the conversational text.

4. The conversation learning service method of claim 1, wherein the providing of the conversational text in the role-playing format comprises providing a first role interface for playing back pronunciation content in a first accent and a second role interface for playing back pronunciation content in a second accent different from the first accent with respect to sentences that are sequentially given in the sentence order of the conversational text.

5. The conversation learning service method of claim 3, further comprising:
registering the uttered voice as pronunciation content in an accent corresponding to the second learning participant.

6. The conversation learning service method of claim 3, wherein the first role interface includes profile information of the first learning participant that registers the pronunciation content, and
the second role interface includes profile information of the second learning participant.

7. The conversation learning service method of claim 3, wherein the second role interface includes an interface for setting a tone of emotion for the uttered voice.

8. The conversation learning service method of claim 3, wherein the second role interface includes an interface for inputting a sentence different from that of the conversational text, and
the conversation learning service method further comprises:
adding a different sentence to a conversation tree that includes the sentences of the conversational text and generating a new conversational text.

9. The conversation learning service method of claim 6, wherein the providing of the first role interface and the second role interface comprises highlighting and displaying profile information corresponding in turn between the profile information of the first learning participant and the profile information of the second learning participant.

10. The conversation learning service method of claim 3, wherein the providing in the role-playing format further comprises sequentially displaying sentences each in which playback of the pronunciation content or recording of the uttered voice is completed as message speech bubbles.

11. The conversation learning service method of claim 3, wherein the providing of the conversational text in the role-playing format further comprises providing at least one of an interface for playing back a pronunciation content and an interface for inputting a positive response in units of sentences each in which the playback of the pronunciation content or the recording of the uttered voice is completed.

12. The conversation learning service method of claim 3, wherein the providing of the conversational text in the role-playing format comprises providing a list of first learning participants selectable as a role-playing opponent based on at least one of a real-time access status and a relationship with the second learning participant.

13. The conversation learning service method of claim 1, wherein the providing of the conversational text in the role-playing format comprises:
providing a topic list that includes topics selectable as a learning topic; and
providing a conversational text on a specific topic selected from the topic list as content for language learning of a second learning participant.

14. The conversation learning service method of claim 13, wherein the providing of the topic list comprises displaying topic information for each topic included in the topic list, and
the topic information includes profile information of at least one first learning participant that participates in recording of a conversational text belonging to a corresponding topic.

15. The conversation learning service method of claim 14, wherein the topic information includes at least one of an object related to the corresponding topic, a number indicating a total of conversational texts belonging to the corresponding topic, and a number indicating a total of first learning participants that participate in recording of the conversational text belonging to the corresponding topic.

16. The conversation learning service method of claim 14, wherein the topic information includes history information of the second learning participant on the conversational text belonging to the corresponding topic.

17. A non-transitory computer-readable recording medium storing instructions that, when executed by a processor, cause the processor to perform the conversation learning service method of claim 1 on a computer device.

18. A computer device comprising:
at least one processor configured to execute computer-readable instructions recorded in a memory,
wherein the at least one processor is configured to execute:
a process of registering audio uttered by a first learning participant as pronunciation content in an accent that represents the first learning participant's country of origin, ethnicity, or region; and
a process of providing a conversational text including at least two sentences in a role-playing format using the pronunciation content corresponding to the sentences.

19. The computer device of claim 18, wherein the conversational text is on a specific topic selected by a second learning participant in a role-playing format using pronunciation content in a specific accent selected by the second learning participant.

20. The computer device of claim 18, wherein the at least one processor is configured to provide a first role interface for playing back the pronunciation content and a second role interface for recording uttered voice of a second learning participant with respect to sentences that are sequentially given in sentence order of the conversational text, or to provide a first role interface for playing back pronunciation content in a first accent and a second role interface for playing back pronunciation content in a second accent different from the first accent with respect to sentences that are sequentially given in sentence order of the conversational text.
